(19) United States
(12) Patent Application Publication
(10) Pub. No.: US 2025/0033500 A1
(43) Pub. Date: Jan. 30, 2025

(54) TRANSFORMER FOR ON-BOARD CHARGER OF ELECTRIC VEHICLE

(71) Applicant: Atum Co., Ltd., Ansan-si (KR)

(72) Inventor: Taeksoo HAN, Seoul (KR)

(21) Appl. No.: 18/777,517

(22) Filed: Jul. 18, 2024

(30) Foreign Application Priority Data
Jul. 26, 2023 (KR) 10-2023-0097857

(51) Int. Cl. B60L 53/22; H01F 27/02; H01F 27/28; H01F 27/32

(52) U.S. Cl. CPC B60L 53/22; H01F 27/02; H01F 27/2823; H01F 27/324; B60L 2210/22

(57) ABSTRACT

Provided relates to a transformer for an on-board charger (OBC) of an electric vehicle, the OBC of the electric vehicle being adapted to charge a high-voltage battery of the electric vehicle with commercial AC power (200V AC) supplied from an electric vehicle charger, the transformer including: a housing in which an insertion space portion is formed; a cover for opening and closing the insertion space portion of the housing; a flat plate type primary coil built in the insertion space portion of the housing and receiving current from the electric vehicle charger; and a plurality of flat plate type secondary coils built in the insertion space portion of the housing and generating induced current by means of magnetic induction of the current flowing to the primary coil, independently of one another, to supply the generated induced current to the high-voltage battery of the electric vehicle.

### CROSS REFERENCE TO RELATED APPLICATION OF THE DISCLOSURE

The present application claims the benefit of Korean Patent Application No. 10-2023-0097857 filed in the Korean Intellectual Property Office on Jul. 26, 2023, the entire contents of which are incorporated herein by reference.

### BACKGROUND OF THE DISCLOSURE

### Field of the Disclosure

The present disclosure relates to a transformer for an on-board charger (OBC) of an electric vehicle.

### Background of the Related Art

A plug-in hybrid electric vehicle (PHEV) and an electric vehicle (EV) (hereinafter, referred to collectively as electric vehicle) is provided with a charger for charging a high-voltage battery that drives the motor of the vehicle with 200V AC, and the charger is called an on-board charger (OBC).

The electric vehicle is provided with an OBC for charging a high-voltage battery that drives the motor of the vehicle with commercial AC power (200V AC) supplied from an electric vehicle charger, the high-voltage battery charged with power converted by and supplied from the OBC, a low voltage DC-DC converter (LDC) for converting a high voltage of the high-voltage battery into a low voltage of 12V and supplying power to electrical components of the vehicle.

The OBC built in an electric vehicle is configured to have a first converter for performing full-wave rectification for the 220V AC voltage supplied from the electric vehicle charger through a bridge diode and boosting the full-wave rectified voltage through a boost converter circuit, a second converter for converting the rectified voltage generated from the first converter into high-frequency AC voltage through a full bridge circuit, a transformer for converting the high-frequency AC voltage of the second converter into a higher voltage and physically insulating the 220V AC from the high-voltage battery, and a rectifier for rectifying and smoothing high-frequency AC high voltage converted through the transformer, converting the rectified AC high voltage into DC voltage, and supplying the DC voltage to the high-voltage battery.

Here, an explanation of a configuration of a transformer for an OBC in a conventional practice will be given.

According to the conventional transformer for the OBC, a primary coil is wound around a bobbin specially made, and next, an insulating tape is applied to the primary coil wound, so that the primary coil is insulated.

After that, a secondary coil is wound around the primary coil.

Next, an insulating tape is applied to the secondary coil wound, so that the secondary coil is insulated.

If the winding work for the secondary coil is performed three times, the insulating tapes are applied to the secondary coils wound whenever the secondary coils are wound, so that the secondary coils are insulated.

However, the conventional transformer for the OBC has the following disadvantages.

Firstly, the transformer itself is considerably large in size. That is, as the secondary coils are wound coaxially on the primary coil wound around the bobbin, the size of the transformer itself is bulky, thereby undesirably causing even a size of the OBC to increase.

Secondly, as the assembly processes of winding the primary coil, insulating the primary coil with the insulating tape wound around the primary coil, winding the secondary coils around the insulating tape, and insulating the secondary coils with the insulating tapes wound around the secondary coils are repeatedly performed, the number of assembly processes increases, thereby undesirably lowering the productivity of the transformer.

Lastly, as the primary coil and the secondary coils are wound manually, the coils wound are not aligned with one another to cause lots of losses therebetween, thereby undesirably making electromagnetic interference (EMI) shielding performance deteriorated badly.

### SUMMARY OF THE DISCLOSURE

Accordingly, the present disclosure has been made in view of the above-mentioned problems occurring in the related art, and it is an object of the present disclosure to provide a transformer for an on-board charger (OBC) of an electric vehicle that is capable of being reduced in height and volume (size), so that the space occupied by the OBC in the electric vehicle becomes small, thereby improving the product competitiveness of the OBC.

It is another object of the present disclosure to provide a transformer for an OBC of an electric vehicle that is capable of decreasing a loss between a primary coil and secondary coils, thereby enhancing efficiency therebetween.

It is yet another object of the present disclosure to provide a transformer for an OBC of an electric vehicle that is capable of supplying large current and high voltage even if the transformer is small in size.

It is still another object of the present disclosure to provide a transformer for an OBC of an electric vehicle that is capable of allowing a primary coil and secondary coils to be kept insulated from one another even at a high voltage in the range of several to tens of kV.

It is yet still another object of the present disclosure to provide a transformer for an OBC of an electric vehicle that is capable of reducing the number of assembling processes for a primary coil and secondary coils, thereby improving product productivity and price competitiveness.

It is another object of the present disclosure to provide a transformer for an OBC of an electric vehicle that is capable of improving electromagnetic interference (EMI) shielding performance thereof.

It is yet another object of the present disclosure to provide a transformer for an OBC of an electric vehicle that is capable of performing insertion work of a primary coil and secondary coils into a housing very easily, conveniently, and accurately and needing no additional terminal arrangement (wiring) for the primary coil and the secondary coils.

It is still another object of the present disclosure to provide a transformer for an OBC of an electric vehicle that is capable of allowing a cover to be fastened to a housing easily, conveniently, and firmly, under a simple configuration.

It is yet another object of the present disclosure to provide a transformer for an OBC of an electric vehicle that is capable of performing wiring work by even an unskilled worker quickly and accurately, without any erroneous wiring.

It is yet still another object of the present disclosure to provide a transformer for an OBC of an electric vehicle that is capable of preventing foreign substances from entering a housing.

It is another object of the present disclosure to provide a transformer for an OBC of an electric vehicle that is capable of allowing the strength of a cover to be appropriately kept even if the cover is thin in thickness, thereby reducing a material cost and improving product durability.

It is still another object of the present disclosure to provide a transformer for an OBC of an electric vehicle that is capable of allowing longitudinal arrangements for a primary coil and secondary coils stacked in upward and downward directions to be performed easily, conveniently, and accurately, while the primary coil and the secondary coil adjacent to the primary coil are being insulated or the adjacent secondary coils are being insulated.

It is yet another object of the present disclosure to provide a transformer for an OBC of an electric vehicle that is capable of allowing wiring work to other parts to be performed very easily and conveniently.

To accomplish the above-mentioned objects, according to the present disclosure, there is provided a transformer for an on-board charger (OBC) of an electric vehicle, the OBC of the electric vehicle being adapted to charge a high-voltage battery of the electric vehicle with commercial AC power (200V AC) supplied from an electric vehicle charger, the transformer including: a housing in which an insertion space portion is formed; a cover for opening and closing the insertion space portion of the housing; a flat plate type primary coil built in the insertion space portion of the housing and receiving current from the electric vehicle charger; a plurality of flat plate type secondary coils built in the insertion space portion of the housing and generating induced current by means of magnetic induction of the current flowing to the primary coil, independently of one another, to supply the generated induced current to the high-voltage battery of the electric vehicle; an upper magnetic core located on top of the cover in such a way as to cover a top of the housing; and a lower magnetic core located on the underside of the housing in such a way as to cover an underside of the housing, wherein the primary coil may be formed of a first adhesion type covered conductive wire made by covering an insulating tape on a copper wire and applying an adhesive onto the outer peripheral surface of the insulating tape to form a bonding layer, and the primary coil may be provided to the form of a hard coil by winding the first adhesion type covered conductive wire in such a way as to have multiple turns by means of a winding member, while forming a first central hole on a center thereof, fusing and curing the applied bonding layer, and joining and aligning the close contact portions of the first adhesion type covered conductive wire by means of the fusing.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a perspective view showing a transformer for an OBC of an electric vehicle according to the present disclosure;

FIG. 2 is a sectional view showing the transformer for an OBC of an electric vehicle according to the present disclosure;

FIG. 3 is an exploded perspective view showing the transformer for an OBC of an electric vehicle according to the present disclosure;

FIG. 4A is a right side view showing the transformer for the OBC according to the present disclosure, in which magnetic cores are removed, that is seen on input/output wire portions of a primary coil;

FIG. 4B is a left side view showing the transformer for the OBC according to the present disclosure, in which magnetic cores are removed, that is seen on input/output wire portions of a secondary coil;

FIG. 5A is a concept showing a thin copper wire adopted as the wire of the transformer for the OBC according to the present disclosure;

FIG. 5B is a sectional view showing layers of first and second adhesion type covered conductive wires of the transformer for the OBC according to the present disclosure; and

FIG. 5C is a concept view showing outer shapes of the first and second adhesion type covered conductive wires of the transformer for the OBC according to the present disclosure, in which multiple thin copper wires are exposed to the outside.

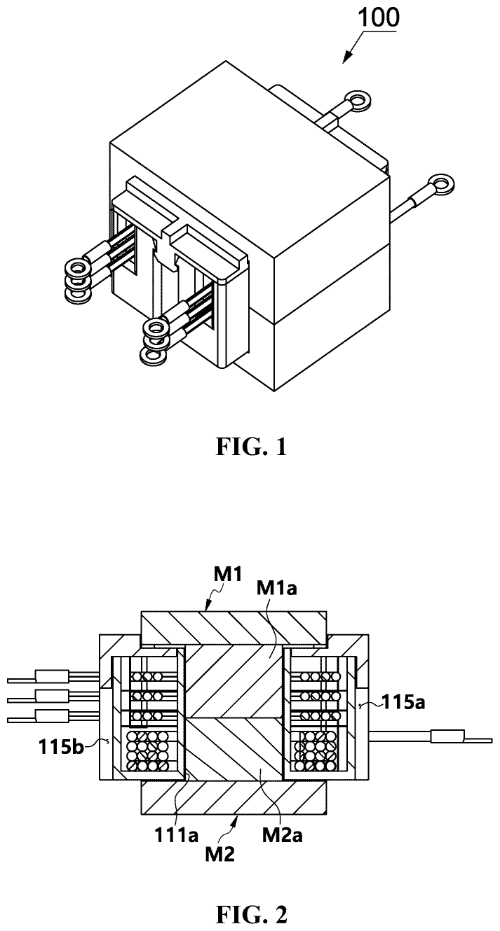

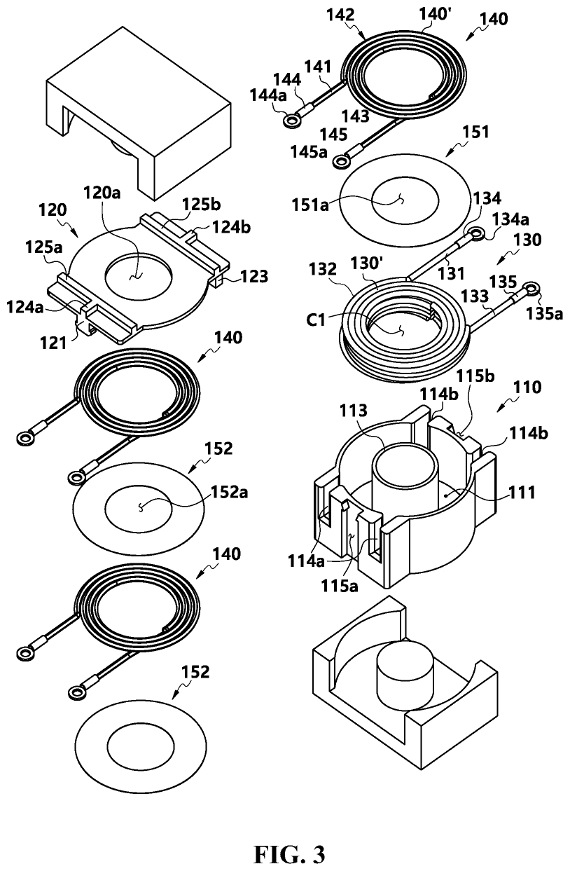

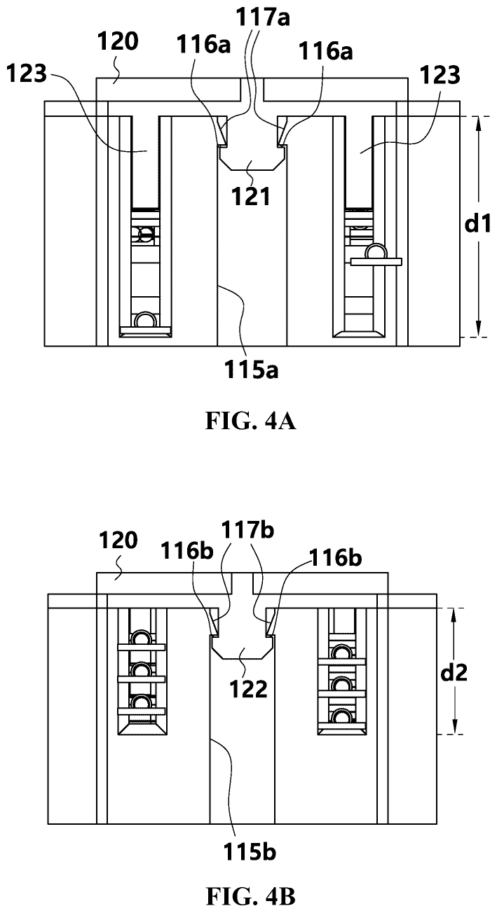

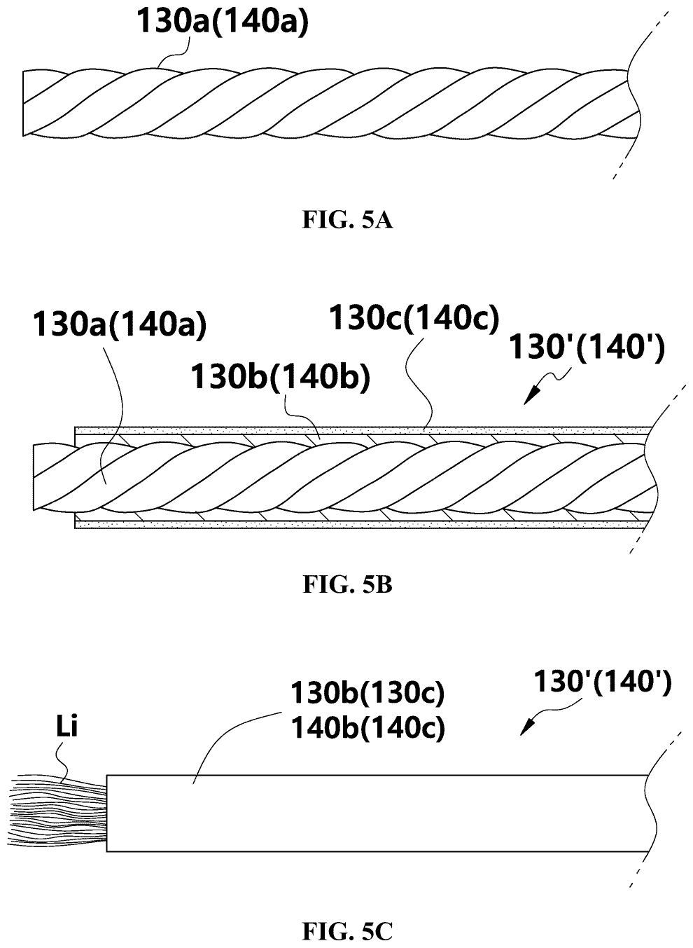

### DETAILED DESCRIPTION OF THE EMBODIMENTS

Hereinafter, an explanation of a transformer for an OBC of an electric vehicle according to an embodiment of the present disclosure will be given in detail with reference to the attached drawings.

According to an embodiment of the present disclosure, there is provided a transformer 100 for an OBC of an electric vehicle, the OBC of the electric vehicle being adapted to charge a high-voltage battery of the electric vehicle with commercial AC power (200V AC) supplied from an electric vehicle charger, the transformer 100 including: a housing 110 in which an insertion space portion Sa is formed; a cover 120 for opening and closing the insertion space portion Sa of the housing 110; a flat plate type primary coil 130 built in the insertion space portion Sa of the housing 110 and receiving current from the electric vehicle charger; a plurality of flat plate type secondary coils 140 built in the insertion space portion Sa of the housing 110 and generating induced current by means of magnetic induction of the current flowing to the primary coil 130, independently of one another, to supply the generated induced current to the high-voltage battery of the electric vehicle; an upper magnetic core M1 located on top of the cover 120 in such a way as to cover a top of the housing 110; and a lower magnetic core M2 located on the underside of the housing 110 in such a way as to cover an underside of the housing 110.

Further, the primary coil 130 is formed of a first adhesion type covered conductive wire 130′ made by covering an insulating tape 130b on a copper wire and applying an adhesive onto the outer peripheral surface of the insulating tape 130b to form a bonding layer 130c, and the primary coil 130 is provided to the form of a hard coil by winding the first adhesion type covered conductive wire 130′ in such a way as to have multiple turns by means of a winding member (not shown), while forming a first central hole C1 on a center thereof, fusing and curing the applied bonding layer 130c with a solvent (e.g., alcohol) or heat (hot air), and joining and aligning (without any irregular outer peripheral surfaces) the close contact portions of the first adhesion type covered conductive wire 130′ by means of the fusing.

Accordingly, no insulation breakdown occurs even at a high voltage in the range of several to tens of kV, while an efficiency between the primary coil and the secondary coils is being kept.

The winding member is a winding jig or winder.

The adhesive is an adhesive paint.

The insulating tape 130b is a Kapton tape.

Further, as mentioned above, the transformer 100 for the OBC of the electric vehicle according to the embodiment of the present disclosure serves to convert the high-frequency alternating current voltage outputted from a second converter of the OBC into a high voltage and to physically insulate the 220 V AC and the high-voltage battery from each other.

The primary coil 130 includes a first input wire portion 131 connected to the electric vehicle charger (especially to the second converter of the OBC) and formed of the first adhesion type covered conductive wire 130′ of a linear type, a primary coil wound portion 132 extending from the first input wire portion 131 and formed by winding the first adhesion type covered conductive wire 130′ in such a way as to have multiple turns to the form of a flat plate, while forming the first central hole C1 on the center thereof, and a first output wire portion 133 formed of the first adhesion type covered conductive wire 130′ of a linear type in such a way as to be connected from the end of the primary coil wound portion 132 to the electric vehicle charger.

The primary coil wound portion 132 is formed in a hard state by automatically winding the first adhesion type covered conductive wire 130′ to the form of the flat plate by means of the winding member so that the wound portions of the first adhesion type covered conductive wire 130′ are brought into close contact with one another and simultaneously aligned in a horizontal direction and/or in a vertical direction (that is, in both horizontal and vertical directions or in either horizontal or vertical direction), fusing and curing the applied adhesive with a solvent (e.g., alcohol) or heat (hot air), and joining and aligning (without any irregular outer peripheral surfaces) the close contact portions of the first adhesion type covered conductive wire 130′ by means of the fusing.

According to the present disclosure, the primary coil 130 and the secondary coils 140 of the transformer 100 for the OBC have the shapes of the flat plates, and then, they are inserted into the single housing 110, so that the transformer 100 for the OBC is reduced in height and size.

Further, a loss between the primary coil 130 and the secondary coils 140 of the transformer 100 for the OBC of the electric vehicle is decreased, thereby enhancing an efficiency therebetween.

Each secondary coil 140 is formed of a second adhesion type covered conductive wire 140′ made by covering an insulating tape 140b on a copper wire and applying an adhesive onto the outer peripheral surface of the insulating tape 140b to form a bonding layer 140c, and the secondary coil 140 is provided to the form of a coil by winding the second adhesion type covered conductive wire 140′ in such a way as to have multiple turns by means of a winding member, while forming a second central hole C2 on a center thereof, fusing and curing the applied bonding layer 140c with a solvent (e.g., alcohol) or heat (hot air), and joining the close contact portions of the second adhesion type covered conductive wire 140′ by means of the fusing.

In detail, the secondary coil 140 is provided to the form of a hard coil by winding the second adhesion type covered conductive wire 140′ in such a way as to have multiple turns by means of the winding member, while forming the second central hole C2 on a center thereof, fusing and curing the applied bonding layer 140c with a solvent (e.g., alcohol) or heat (hot air), and joining and aligning (without any irregular outer peripheral surfaces) the close contact portions of the second adhesion type covered conductive wire 140′ by means of the fusing.

The secondary coil 140 includes a second input wire portion 141 connected to the electric vehicle charger (especially to the second converter of the OBC) and formed of the second adhesion type covered conductive wire 140′ of a linear type, a secondary coil wound portion 142 extending from the second input wire portion 141 and formed by winding the second adhesion type covered conductive wire 140′ in such a way as to have multiple turns to the form of a flat plate, while forming the second central hole C2 on the center thereof, and a second output wire portion 143 formed of the second adhesion type covered conductive wire 140′ of a linear type in such a way as to be connected from the end of the secondary coil wound portion 142 to the electric vehicle charger.

The secondary coil wound portion 142 is provided to the form of a hard coil by winding the second adhesion type covered conductive wire 140′ by means of the winding member to form the second central hole C2 on the center thereof, fusing and curing the applied bonding layer 140c with the solvent (e.g., alcohol) or heat (hot air), and joining and aligning (without any irregular outer peripheral surfaces) the close contact portions of the second adhesion type covered conductive wire 140′ by means of the fusing.

According to the above-mentioned configurations of the primary coil 130 and the secondary coils 140, the primary coil 130 and the secondary coils 140 can supply large current and high voltage even if they are small in size.

Further, the primary coil 130 and the secondary coils 140 of the transformer for the OBC are made by means of fusing, so that the wound portions of the primary coil 130 and the secondary coils 140 have high degrees of contact, and further, the contact among the primary coil 130 and the secondary coils 140 is improved, so that a loss thereamong is reduced to improve the efficiency thereamong. Further, the transformer as a product is reduced in height (to a height of 70% of the conventional transformer for the OBC) and in size (to a size of 70% of the conventional transformer for the OBC).

As the height and size of the transformer for the OBC are reduced, the OBC itself is decreased in size, so that the space occupied by the OBC in the electric vehicle becomes small and the OBC itself is lightweight, thereby improving the product competitiveness of the OBC of the electric vehicle.

Further, the primary coil 130 and the secondary coils 140 of the transformer for the OBC according to the embodiment of the present disclosure are made by means of a winding jig or winder, which makes it possible to automatedly produce the primary coil 130 and the secondary coils 140, so that the number of assembling processes is reduced (to 50% of the number of assembling processes for the conventional transformer for the OBC), thereby greatly improving their productivity and price competitiveness.

Furthermore, well-known conductive wires may be used freely as the copper wires covered with the insulating tapes 130b and 140b.

That is, the copper wire for the primary coil 130 is a bare copper wire, a thin copper wire 130a made by twisting multi-stranded thin copper wires Li, or a bare copper wire or thin copper wire 130a onto which insulation coating is applied. In any case, such copper wires may be within the technical scope of the present disclosure.

Like the copper wire for the primary coil 130, the copper wire for the secondary coil 140 is a bare copper wire, a thin copper wire 130a made by twisting multi-stranded thin copper wires Li, or a bare copper wire or thin copper wire 130a onto which insulation coating is applied. In any case, such copper wires may be within the technical scope of the present disclosure.

The primary coil 130 is wound to allow the first input wire portion 131 and the first output wire portion 133 to be arranged toward the electric vehicle charger in the same direction as each other, and each secondary coil 140 is wound to allow the second input wire portion 141 and the second output wire portion 143 to be arranged in the same direction as each other.

The housing 110 includes a flat bottom 111, a peripheral portion 112 erecting upward from the bottom 111, and a fitting pipe 113 protruding upward from the bottom 111, and the insertion space portion Sa is defined by the space between the fitting tube 113 and the peripheral portion 112. Further, the housing 110 has a pair of primary drawing slits 114a spaced apart from each other by a given distance on the left side of the peripheral portion 112 in such a way as to be open on top thereof and concave downward and a pair of secondary drawing slits 114b spaced apart from each other by a given distance on the right side of the peripheral portion 112 in such a way as to be open on top thereof and concave downward.

As the primary coil wound portion 132 of the primary coil 130 moves from top to bottom, the first central hole C1 is fitted to the fitting pipe 113, while being fitted between the peripheral portion 112 and the fitting tube 113, and simultaneously, as the first input wire portion 131 and the first output wire portion 133 move down together with the primary coil wound portion 132, they move from top to bottom along the primary drawing slits 114a and are thus fitted thereto.

As the secondary coil wound portion 142 of each secondary coil 140 moves from top to bottom, the second central hole C2 is fitted to the fitting pipe 113, while being fitted between the peripheral portion 112 and the fitting tube 113, and simultaneously, as the second input wire portion 141 and the second output wire portion 143 move down together with the secondary coil wound portion 142, they move from top to bottom along the secondary drawing slits 114b and are thus fitted thereto.

As the primary coil 130 and each secondary coil 140 simply move down along the primary drawing slits 114a and the secondary drawing slits 114b and are then inserted thereinto, their insertion work into the housing 110 is performed very easily, conveniently, and accurately, and further, no additional terminal arrangement (wiring) for the primary coil 130 and each secondary coil 140 is needed, thereby ensuring good assembling workability.

In the transformer 100 for the OBC of the electric vehicle according to the embodiment of the present disclosure, the housing 110 includes a first guide channel 115a concavely formed between the pair of primary drawing slits 114a on the left side of the peripheral portion 112 toward a central portion where the primary coil 130 and the secondary coils 140 are located and a second guide channel 115b concavely formed between the pair of secondary drawing slits 114a on the right side of the peripheral portion 112 toward the central portion where the primary coil 130 and the secondary coils 140 are located, and the first guide channel 115a has first locking steps 116a protruding inward therefrom, while the second guide channel 115b has second locking steps 116b protruding inward therefrom. Further, the cover 120 includes a first hook 121 vertical downward from the left end thereof, moving down along the first guide channel 115a, and lockedly fastened to the first locking steps 116a and a second hook 122 vertical downward from the right end thereof, moving down along the second guide channel 115b, and lockedly fastened to the second locking steps 116b.

Under the above-mentioned simple configuration, the cover 120 is fastened to the housing 110 easily, conveniently, and firmly.

In the transformer 100 for the OBC of the electric vehicle according to the embodiment of the present disclosure, the housing 110 has first guide slant surfaces 117a formed on the first guide channel 115a above the first locking steps 116a in such a way as to become narrow in width therebetween from top to bottom to allow the first hook 121 to be smoothly lockedly fastened to the first locking steps 116a and second guide slant surfaces 117b formed on the second guide channel 115b above the second locking steps 116b in such a way as to become narrow in width therebetween from top to bottom to allow the second hook 122 to be smoothly lockedly fastened to the second locking steps 116b.

Accordingly, the cover 120 is fastened to the housing 110 more easily, conveniently, and softly.

The primary coil 130 is located under the secondary coils 140, and a depth d1 of each primary drawing slit 114a is higher than a depth d2 of each secondary drawing slit 114b, so that a primary side and a secondary side of the transformer can be identified.

As a result, the wiring work of the transformer 100 for the OBC can be performed by even an unskilled worker quickly and accurately, without any erroneous wiring, thereby improving the productivity of the transformer.

In the transformer 100 for the OBC of the electric vehicle according to the embodiment of the present disclosure, the cover 120 further includes blocking bars 213 vertical downward from the left end thereof in such a way as to correspond to the positions of the primary drawing slits 114a, moving down along the primary drawing slits 114a if the cover 120 is fastened to the housing 110, and guiding the moving down and fastening to the housing 110, while preventing foreign substances from entering the primary drawing slits 114a.

Accordingly, the work where the cover 120 moves down and is coupled to the housing 110 is performed accurately, conveniently, and quickly, and further, the foreign substances are prevented from entering the housing 110.

In the transformer 100 for the OBC of the electric vehicle according to the embodiment of the present disclosure, the cover 120 further includes a first reinforcing rib 124a protruding from a top thereof in such a way as to be located just above the first hook 121 if the cover 120 is fastened to the housing 110 and thus preventing the first hook 121 from being broken when the cover 120 is fastened to the housing 110 and a second reinforcing rib 124b protruding from a top thereof in such a way as to be located just above the second hook 122 if the cover 120 is fastened to the housing 110 and thus preventing the second hook 122 from being broken when the cover 120 is fastened to the housing 110.

In the transformer 100 for the OBC of the electric vehicle according to the embodiment of the present disclosure, the cover 120 further includes a first twist prevention rib 125a having the shape of a bar in forward and backward directions on the left end of the top thereof in such a way as to cross the end of the first reinforcing rib 124a to the form of T and thus to prevent twist from occurring if the upper magnetic core M1 is inserted into the fitting pipe 113 and a second twist prevention rib 125b having the shape of a bar in forward and backward directions on the right end of the top thereof in such a way as to cross the end of the second reinforcing rib 124b to the form of T and thus to prevent twist from occurring if the upper magnetic core M1 is inserted into the fitting pipe 113.

Even if the cover 120 is thin in thickness, accordingly, the strength of the cover 120 is appropriately kept, thereby reducing a material cost and improving product durability.

The transformer 100 for the OBC of the electric vehicle according to the embodiment of the present disclosure further includes a first adhesive sheet 151 having a first through hole 151a formed on the center thereof to fit the fitting pipe 113 thereto, placed between the primary coil 130 and the secondary coil 140 most closely adjacent to the primary coil 130 to insulate the primary coil 130 and the secondary coil 140 from each other and to allow the primary coil 130 and the secondary coil 140 to be adhesive thereto and one or more second adhesive sheets 152 each having a second through hole 152a formed on the center thereof to fit the fitting pipe 113 thereto, placed between the adjacent secondary coils 140 to insulate the adjacent secondary coils 140 from each other and to allow the secondary coils 140 to be adhesive thereto.

While the primary coil 130 and the secondary coil 140 adjacent to the primary coil 130 are being insulated or the adjacent secondary coils 140 are being insulated, accordingly, longitudinal arrangements for the primary coil 130 and the secondary coils 140 stacked in upward and downward (height) directions can be performed easily, conveniently, and accurately.

In the transformer 100 for the OBC of the electric vehicle according to the embodiment of the present disclosure, the housing 110 has a through hole 111a formed on the center of the bottom 111 so that the fitting tube 113 extends upward from the inner peripheral surface of the through hole 111a, and the cover 120 has a through hole 120a formed on the center thereof in such a manner as to face the through hole 111a of the housing 110 so that a middle leg M1a of the upper magnetic core M1 passes through the through hole 120a and is fittedly inserted into the fitting pipe 113 and a middle leg M2a of the lower magnetic core M2 passes through the through hole 111a and is fittedly inserted into the fitting pipe 113.

In the transformer 100 for the OBC of the electric vehicle according to the embodiment of the present disclosure, the primary coil 130 further includes a first input terminal 134 connected conductively to the end of the first input wire portion 131 and having a first input terminal fixing hole 134a formed thereon and a first output terminal 135 connected conductively to the end of the first output wire portion 133 and having a first output terminal fixing hole 135a formed thereon, and each secondary coil 140 further includes a second input terminal 144 connected conductively to the end of the second input wire portion 141 and having a second input terminal fixing hole 144a formed thereon and a second output terminal 145 connected conductively to the end of the second output wire portion 143 and having a second output terminal fixing hole 145a formed thereon.

Accordingly, the wiring work for the transformer 100 for the OBC can be performed more easily and conveniently.

For example, desirably, the thin copper wire 130a of the first adhesion type covered conductive wire 130′ is desirably made by twisting 1,000 to 2,500 stranded thin copper wires Li, and more desirably, the thin copper wire 130a of the first adhesion type covered conductive wire 130′ is desirably made by twisting 1,300 to 2,000 stranded thin copper wires Li.

Accordingly, the thin copper wire having optimized thickness and strands has performance of large current and high voltage.

As described above, the transformer for the OBC of the electric vehicle according to the embodiment of the present disclosure has the following advantages.

Firstly, the height and volume (size) of the transformer for the OBC can be reduced, so that the space occupied by the OBC in the electric vehicle becomes small, thereby improving the product competitiveness of the OBC of the electric vehicle.

Secondly, a loss between the primary coil and the secondary coils of the transformer for the OBC of the electric vehicle can be decreased, thereby enhancing efficiency therebetween.

Thirdly, even if the transformer is small in size, the transformer can supply large current and high voltage.

Fourthly, the primary coil and the secondary coils of the transformer for the OBC can be kept insulated from one another even at a high voltage in the range of several to tens of kV.

Fifthly, the number of assembling processes for the primary coil and the secondary coils can be reduced, thereby improving product productivity and price competitiveness.

Sixthly, the electromagnetic interference (EMI) shielding performance of the transformer for the OBC can be improved.

Seventhly, the insertion work of the primary coil and the secondary coils into the housing can be performed very easily, conveniently, and accurately, and further, no additional terminal arrangement (wiring) for the primary coil and the secondary coils can be needed.

Eighthly, the cover can be fastened to the housing easily, conveniently, and firmly, under the simple configuration thereof.

Ninthly, the wiring work of the transformer for the OBC can be performed by even an unskilled worker quickly and accurately, without any erroneous wiring.

Tenthly, the foreign substances can be prevented from entering the housing.

Eleventhly, even if the cover is thin in thickness, the strength of the cover can be appropriately kept, thereby reducing a material cost and improving product durability.

Twelfthly, while the primary coil and the secondary coil adjacent to the primary coil are being insulated or the adjacent secondary coils are being insulated, longitudinal arrangements for the primary coil and the secondary coils stacked in upward and downward directions can be performed easily, conveniently, and accurately.

Lastly, wiring work of the transformer for the OBC to other parts can be performed very easily and conveniently.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

It is therefore intended that the scope of the invention be limited not by this detailed description, but rather by the claims appended hereto.

What is claimed is:

1. A transformer for an on-board charger (OBC) of an electric vehicle, the OBC of the electric vehicle being adapted to charge a high-voltage battery of the electric vehicle with commercial AC power (200V AC) supplied from an electric vehicle charger, the transformer comprising:
a housing (110) in which an insertion space portion (Sa) is formed;
a cover (120) for opening and closing the insertion space portion (Sa) of the housing (110);
a flat plate type primary coil (130) built in the insertion space portion (Sa) of the housing (110) and receiving current from the electric vehicle charger;
a plurality of flat plate type secondary coils (140) built in the insertion space portion (Sa) of the housing (110) and generating induced current by means of magnetic induction of the current flowing to the primary coil (130), independently of one another, to supply the generated induced current to the high-voltage battery of the electric vehicle;
an upper magnetic core (M1) located on top of the cover (120) in such a way as to cover a top of the housing (110); and
a lower magnetic core (M2) located on the underside of the housing (110) in such a way as to cover an underside of the housing (110),
wherein the primary coil (130) is formed of a first adhesion type covered conductive wire (130)′ made by covering an insulating tape (130b) on a copper wire and applying an adhesive onto the outer peripheral surface of the insulating tape (130b) to form a bonding layer (130c), and the primary coil (130) is provided to the form of a hard coil by winding the first adhesion type covered conductive wire (130′) in such a way as to have multiple turns by means of a winding member, while forming a first central hole (C1) on a center thereof, fusing and curing the applied bonding layer (130c), and joining and aligning the close contact portions of the first adhesion type covered conductive wire (130′) by means of the fusing.

2. The transformer according to claim 1, wherein the primary coil (130) comprises:
a first input wire portion (131) connected to the electric vehicle charger and formed of the first adhesion type covered conductive wire (130′) of a linear type;
a primary coil wound portion (132) extending from the first input wire portion (131) and formed by winding the first adhesion type covered conductive wire (130′) in such a way as to have multiple turns to the form of a flat plate, while forming the first central hole (C1) on the center thereof; and
a first output wire portion (133) formed of the first adhesion type covered conductive wire (130′) of a linear type in such a way as to be connected from the end of the primary coil wound portion (132) to the electric vehicle charger,
whereby the primary coil wound portion (132) is provided to a hard state by automatically winding the first adhesion type covered conductive wire (130′) to the form of the flat plate by means of the winding member so that the wound portions of the first adhesion type covered conductive wire (130′) are brought into close contact with one another and simultaneously aligned in a horizontal direction and/or in a vertical direction, fusing and curing the applied bonding layer (130c), and joining and aligning the close contact portions of the first adhesion type covered conductive wire (130′) by means of the fusing.

3. The transformer according to claim 1, wherein each secondary coil (140) is formed of a second adhesion type covered conductive wire (140′) made by covering an insulating tape (140b) on a copper wire and applying an adhesive onto the outer peripheral surface of the insulating tape (140b) to form a bonding layer (140c), and the secondary coil (140) is provided to the form of a coil by winding the second adhesion type covered conductive wire (140′) in such a way as to have multiple turns by means of a winding member, while forming a second central hole (C2) on a center thereof, fusing and curing the applied bonding layer (140c), and joining the close contact portions of the second adhesion type covered conductive wire (140′) by means of the fusing.

4. The transformer according to claim 3, wherein the secondary coil (140) comprises:
a second input wire portion (141) connected to the electric vehicle charger and formed of the second adhesion type covered conductive wire (140′) of a linear type;
a secondary coil wound portion (142) extending from the second input wire portion (141) and formed by winding the second adhesion type covered conductive wire (140′) in such a way as to have multiple turns to the form of a flat plate, while forming the second central hole (C2) on the center thereof; and
a second output wire portion (143) formed of the second adhesion type covered conductive wire (140′) of a linear type in such a way as to be connected from the end of the secondary coil wound portion (142) to the electric vehicle charger,
whereby the secondary coil wound portion (142) is provided to the form of a hard coil by winding the second adhesion type covered conductive wire (140′) in such a way as to have multiple turns by means of the winding member, while forming the second central hole (C2) on the center thereof, fusing and curing the applied bonding layer (140c), and joining and aligning the close contact portions of the second adhesion type covered conductive wire (140′) by means of the fusing.

5. The transformer according to claim 4, wherein the primary coil (130) is wound to allow the first input wire portion (131) and the first output wire portion (133) to be arranged toward the electric vehicle charger in the same direction as each other, while each secondary coil (140) is wound to allow the second input wire portion (141) and the second output wire portion (143) to be arranged in the same direction as each other, and
the housing (110) comprises:
a flat bottom (111);
a peripheral portion (112) erecting upward from the bottom (111); and
a fitting pipe (113) protruding upward from the bottom (111),
the insertion space portion (Sa) being defined by the space between the fitting tube (113) and the peripheral portion (112),
the peripheral portion (112) comprising a pair of primary drawing slits (114a) spaced apart from each other by a given distance on the left side thereof in such a way as to be open on top thereof and concave downward and a pair of secondary drawing slits (114b) spaced apart from each other by a given distance on the right side thereof in such a way as to be open on top thereof and concave downward,
whereby as the primary coil wound portion (132) of the primary coil (130) moves from top to bottom, the first central hole (C1) is fitted to the fitting pipe (113), while being fitted between the peripheral portion (112) and the fitting tube (113), and simultaneously, as the first input wire portion (131) and the first output wire portion (133) move down together with the primary coil wound portion (132), the first input wire portion (131) and the first output wire portion (133) move from top to bottom along the primary drawing slits (114a) and are thus fitted thereto; and
as the secondary coil wound portion (142) of each secondary coil (140) moves from top to bottom, the second central hole (C2) is fitted to the fitting pipe (113), while being fitted between the peripheral portion (112) and the fitting tube (113), and simultaneously, as the second input wire portion (141) and the second output wire portion (143) move down together with the secondary coil wound portion (142), the second input wire portion (141) and the second output wire portion (143) move from top to bottom along the secondary drawing slits (114b) and are thus fitted thereto.

6. The transformer according to claim 5, wherein the housing (110) comprises:
a first guide channel (115a) concavely formed between the pair of primary drawing slits (114a) on the left side of the peripheral portion (112) toward a central portion where the primary coil (130) and the secondary coils (140) are located; and
a second guide channel (115b) concavely formed between the pair of secondary drawing slits (114a) on the right side of the peripheral portion (112) toward the central portion where the primary coil (130) and the secondary coils (140) are located,
the first guide channel (115a) having first locking steps (116a) protruding inward therefrom, while the second guide channel (115b) having second locking steps (116b) protruding inward therefrom, and
the cover (120) comprises:
a first hook (121) vertical downward from the left end thereof, moving down along the first guide channel (115a), and lockedly fastened to the first locking steps (116a); and
a second hook (122) vertical downward from the right end thereof, moving down along the second guide channel (115b), and lockedly fastened to the second locking steps (116b).

7. The transformer according to claim 6, wherein the housing (110) comprises:
first guide slant surfaces (117a) formed on the first guide channel (115a) above the first locking steps (116a) in such a way as to become narrow in width therebetween from top to bottom to allow the first hook (121) to be smoothly lockedly fastened to the first locking steps (116a); and
second guide slant surfaces (117b) formed on the second guide channel (115b) above the second locking steps (116b) in such a way as to become narrow in width therebetween from top to bottom to allow the second hook (122) to be smoothly lockedly fastened to the second locking steps (116b).

8. The transformer according to claim 5, wherein the primary coil (130) is located under the secondary coils (140), and a depth (d1) of each primary drawing slit (114a) is higher than a depth (d2) of each secondary drawing slit (114b), whereby a primary side and a secondary side of the transformer are identified.

9. The transformer according to claim 5, wherein the cover (120) comprises blocking bars (213) vertical downward from the left end thereof in such a way as to correspond to the positions of the primary drawing slits (114a), moving down along the primary drawing slits (114a) if the cover (120) is fastened to the housing (110), and guiding the moving down and fastening to the housing (110), while preventing foreign substances from entering the primary drawing slits (114a).

10. The transformer according to claim 6, wherein the cover (120) comprises:
a first reinforcing rib (124a) protruding from a top thereof in such a way as to be located just above the first hook (121) if the cover (120) is fastened to the housing (110) and thus preventing the first hook (121) from being broken when the cover (120) is fastened to the housing (110); and
a second reinforcing rib (124b) protruding from a top thereof in such a way as to be located just above the second hook (122) if the cover (120) is fastened to the housing (110) and thus preventing the second hook (122) from being broken when the cover (120) is fastened to the housing (110).
